(19) United States
(12) Patent Application Publication
(10) Pub. No.: US 2026/0058184 A1
(43) Pub. Date: Feb. 26, 2026

(54) POSITIONING APPARATUS FOR CELL ELECTRODE PLATE GROUPS OF LEAD-ACID BATTERY

(71) Applicant: BATTERY TECHNOLOGY SOURCE CO. LTD., TAICHUNG CITY (TW)

(72) Inventor: FU MEI HO, TAICHUNG CITY (TW)

(21) Appl. No.: 18/813,164

(22) Filed: Aug. 23, 2024

(51) Int. Cl. H01M 10/04; H01M 10/16

(52) U.S. Cl. CPC H01M 10/0404; H01M 10/16

(57) ABSTRACT

A positioning apparatus includes a support structure including a top plate and legs extending downward from four corners of the top plate; a hoisting unit including a first hoisting plate, piston members, a second hoisting plate, two pressing blocks, and a first actuator; and a clamping unit including two opposite second actuators and two pushing blocks. The positioning apparatus is used for cell electrode plate groups of a lead-acid battery.

### FIELD OF THE INVENTION

The invention relates to lead-acid batteries and more particularly to a positioning apparatus for cell electrode plate groups of a lead-acid battery.

### BACKGROUND OF THE INVENTION

Lead-acid batteries are widely used in motor vehicles or uninterruptible power supplies (UPSs). With the advancement of technology, the size of lead-acid battery becomes smaller, and its density is also increased. The conventional lead-acid battery comprises a plurality of compartments disposed in a housing. Each compartment accommodates a cell electrode plate group. The cell electrode plate group comprises a plurality of electrode plates and a plurality of separation plates alternated and stacked. A tab protrudes from a top of each electrode plate. These tabs are respectively connected to one of a plurality of lead bridges that supply electric current to each electrode plate in series based on anode of the electric current entering it and cathode of the same leaving it. Thus, the electric current flows from the anode to the cathode through the lead bridge.

However, regarding the conventional lead-acid batteries it is required to manually place the cell electrode plate group in the compartment, and an employee must use a tool to press the lead bridges so that the cell electrode plate groups can be correctly positioned and fastened in each compartment. Unfortunately, the above process of assembling the lead-acid battery is labor-intensive and time-consuming in addition to low efficiency.

Thus, the need for improvement still exists.

### SUMMARY OF THE INVENTION

It is therefore one object of the invention to provide a positioning apparatus for cell electrode plate groups of a lead-acid battery, comprising a support structure comprising a top plate and a plurality of legs extending downward from four corners of the top plate to support the top plate; a hoisting unit comprising a first hoisting plate, a plurality of piston members, a second hoisting plate, two pressing blocks, and a first actuator wherein the first hoisting plate is disposed above the top plate, first ends of the piston members are secured to a bottom of the first hoisting plate and second ends thereof pass through the top plate to secure to the second hoisting plate, the second hoisting plate is disposed under the top plate, the pressing blocks are secured to a bottom of the second hoisting plate and spaced apart by a predetermined distance, the first actuator passes through the first hoisting plate to secure to the top plate, and the first actuator includes a first piston passing through the top plate and threadedly secured to the second hoisting plate so that the first piston is configured to move the second hoisting plate which in turn lifts or lowers the pressing blocks, the piston members, and the first hoisting plate; and a clamping unit comprising two opposite second actuators and two pushing blocks wherein each of the second actuators are secured to a bottom of the second hoisting plate and disposed externally of the pressing block, and each of the second actuators include at least one second piston having an end secured to the pushing block so that the at least one second piston is configured to move one of the pushing blocks forward to approach one of the pressing blocks or rearward to leave one of the pressing blocks.

The invention has the following advantages and benefits in comparison with the conventional art: with the provision of the hoisting unit and the clamping unit, it is possible to finish the pressing and positioning process of the lead-acid battery. The drawbacks of the conventional assembling process of the lead-acid battery are eliminated. Moreover, both labor and time are saved, and efficiency is increased.

The above and other objects, features and advantages of the invention will become apparent from the following detailed description taken with the accompanying drawings.

### BRIEF DESCRIPTION OF THE DRAWINGS

FIG. 1 is a perspective view of a bed with a positioning apparatus according to a preferred embodiment of the invention mounted thereon and a controlling unit mounted on the positioning apparatus;

FIG. 2 is a perspective view of the positioning apparatus;

FIG. 3 is a front view of the positioning apparatus;

FIG. 4 is an exploded view of the hoisting unit and the micro adjustment unit of the positioning apparatus;

FIG. 5 is an exploded view of the support structure and the clamping unit of the positioning apparatus;

FIG. 6 is a perspective view of a half-finished lead-acid battery to be processed by the positioning apparatus;

FIG. 7 is a front view of the positioning apparatus with the hoisting unit being lowered and the plate member approaching both the first nut set and the second nut set;

FIG. 8 is a greatly enlarged view of the area in circle A of FIG. 7;

FIG. 9 is a view similar to FIG. 7 showing the clamping unit approaching the lead bridges;

FIG. 10 is a view similar to FIG. 9 showing the clamping unit leaving the lead bridges;

FIG. 11 is a front view of the positioning apparatus with the hoisting unit being lifted and the plate member leaving both the first nut set and the second nut set;

FIG. 12 is a side elevation of the positioning apparatus with the groove of the plate member leaving the first threaded shank;

FIG. 13 is a front view of the positioning apparatus with the hoisting unit being lowered again and the first hoisting plate approaching both the first nut set and the second nut set;

FIG. 14 is a side elevation of FIG. 13; and

FIG. 15 is a front view of the positioning apparatus showing the clamping unit approaching the lead bridges again.

### DETAILED DESCRIPTION OF THE INVENTION

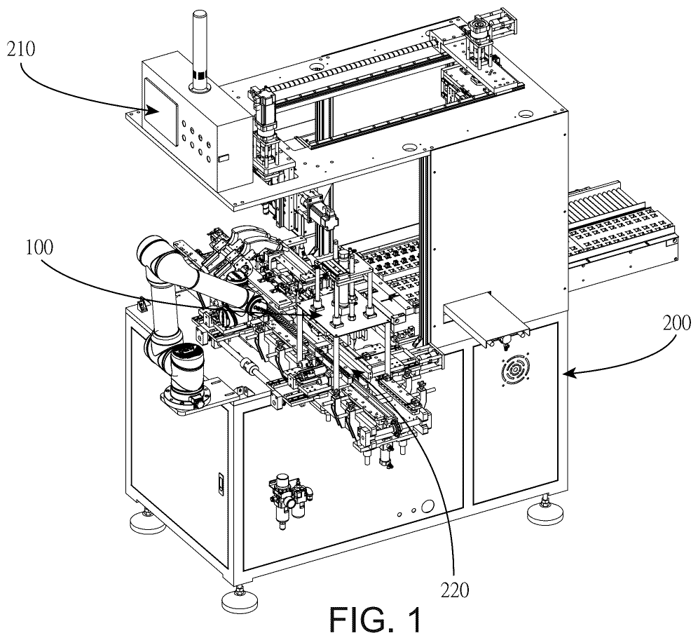

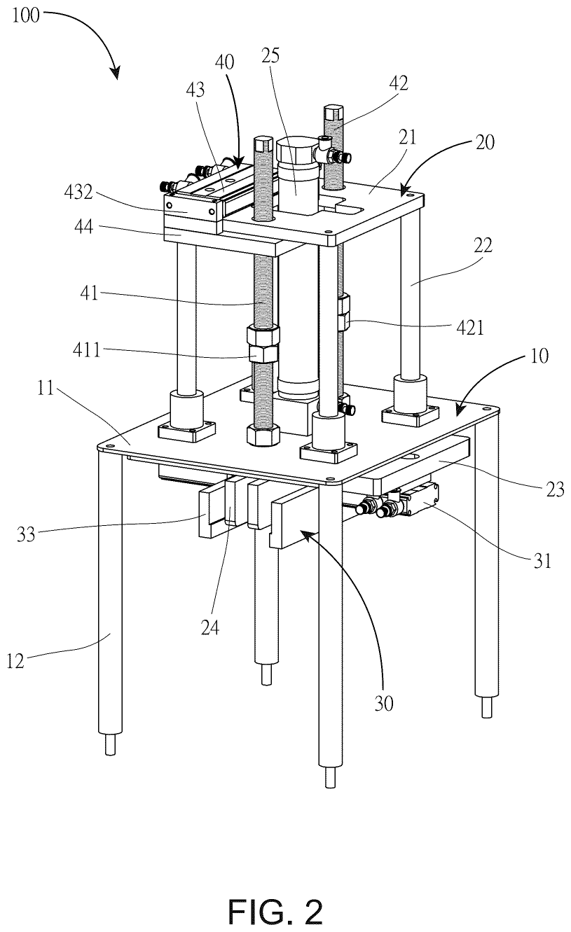

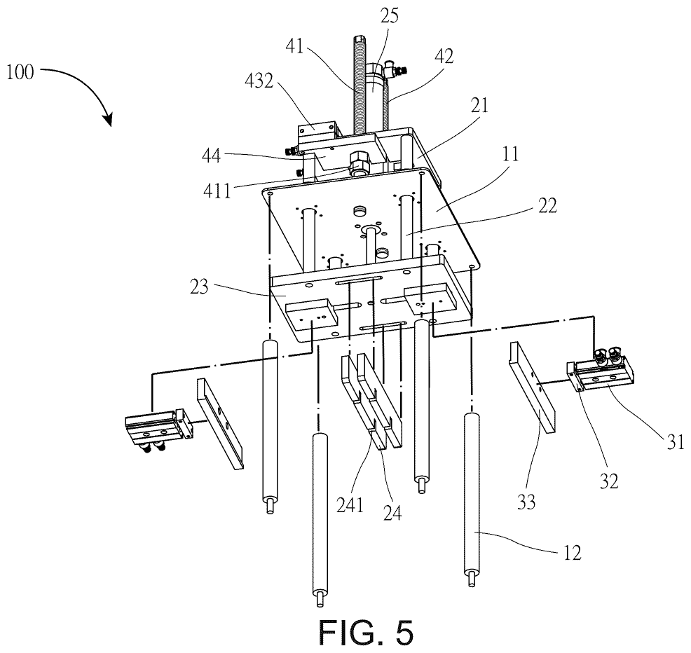

Referring to FIGS. 1 to 5, a positioning apparatus 100 according to a preferred embodiment of the invention is provided on a bed 200. A controlling unit 210 is provided on the positioning apparatus 100 above the bed 200 and a movement unit 220 is provided on the bed 200 respectively. The positioning apparatus 100 is electrically connected to the controlling unit 210 and comprises the following components as discussed in detail below.

A support structure 10 comprises a rectangular top plate 11 and a plurality of (four are shown) legs 12 extending downward from four corners of the top plate 11 to fasten on the movement unit 220. As a result, the top plate 11 is supported by the legs 12.

A hoisting unit 20 comprises a first hoisting plate 21, a plurality of piston members 22, a second hoisting plate 23, two pressing blocks 24, and a first actuator 25. The first hoisting plate 21 is provided above the top plate 11. One ends of the piston members 22 are secured to a bottom of the first hoisting plate 21 and the other ends thereof pass through the top plate 11 to secure to the second hoisting plate 23. The second hoisting plate 23 is disposed under the top plate 11. The pressing blocks 24 are secured to a bottom of the second hoisting plate 23 and spaced apart by a predetermined distance. Each pressing block 24 includes two spaced troughs 241. The first actuator 25 passes through the first hoisting plate 21 to secure to the top plate 11. The first actuator 25 includes a first piston 251 passing through the top plate 11, and a nut 252 for securing an end of the first piston 251 to the second hoisting plate 23. Thus, the first piston 251 may move the second hoisting plate 23 which in turn lifts or lowers the pressing blocks 24, the piston members 22, and the first hoisting plate 21.

A clamping unit 30 comprises two opposite second actuators 31, two follower plates 32, and two pushing blocks 33. Each second actuator 31 is secured to a bottom of the second hoisting plate 23 and disposed externally of the pressing block 24. Each second actuator 31 includes at least one second piston 311 having an end secured to the follower plate 32 which in turn is secured to the pushing block 33. Thus, the second piston 311 may move the follower plate 32 which in turn moves the pushing block 33 forward to approach the pressing block 24 or rearward to leave the pressing block 24.

As stated above, the second actuators 31 are secured to the bottom of the second hoisting plate 23. When the first piston 251 pushes the second hoisting plate 23, all of the second actuator 31, the follower plate 32, and the pushing block 33 lift or lower.

A micro adjustment unit 40 comprises a first threaded shank 41, a second threaded shank 42, a third actuator 43, a plate member 44, a first sensor 45, and a second sensor 46. The first actuator 25 is provided between the first threaded shank 41 and the second threaded shank 42. Each of the first threaded shank 41 and the second threaded shank 42 pass through the first hoisting plate 21 to secure to the top plate 111. The first threaded shank 41 includes a first nut set 411 on an intermediate portion and the second threaded shank 42 includes a second nut set 421 on an intermediate portion respectively. The third actuator 43 is provided on a top of the first hoisting plate 21 and includes two third pistons 431 and an idler plate 432 secured to ends of the third pistons 431. The idler plate 432 is also secured to a top of the plate member 44. The plate member 44 includes a groove 441 for allowing the first threaded shank 41 to pass through. The first sensor 45 is provided on an upper portion of the first actuator 25 and the second sensor 46 is provided on a lower portion of the first actuator 25. Each of the first sensor 45 and the second sensor 46 are used to sense a position of the first piston 251 which either extends or retracts.

Each of position of the first nut set 411 on the first threaded shank 41 and position of the second nut set 421 on the second threaded shank 42 can be adjusted by a user.

The first actuator 25, the second actuators 31, and the third actuator 44 are pneumatic or hydraulic cylinders.

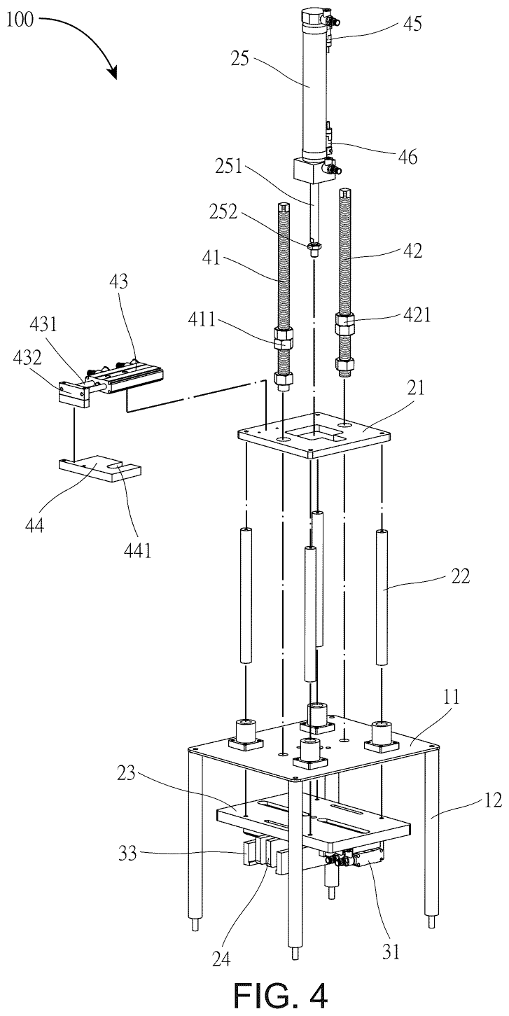

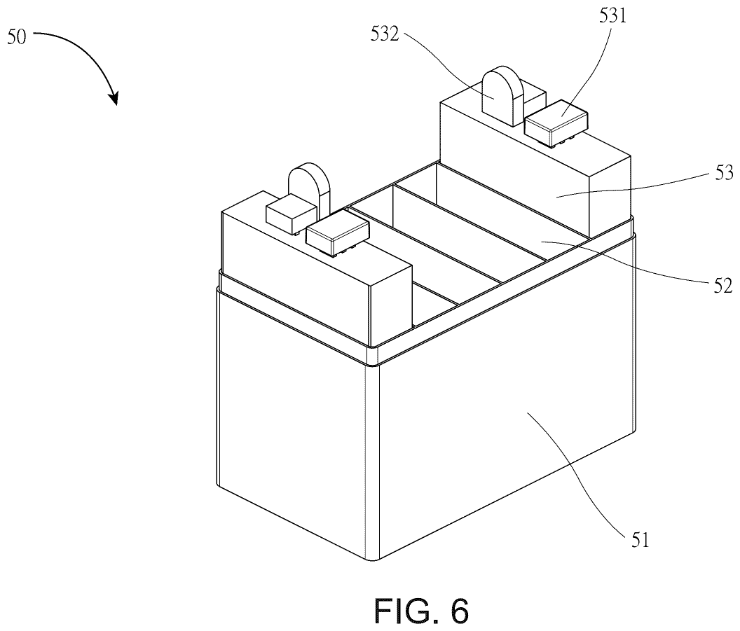

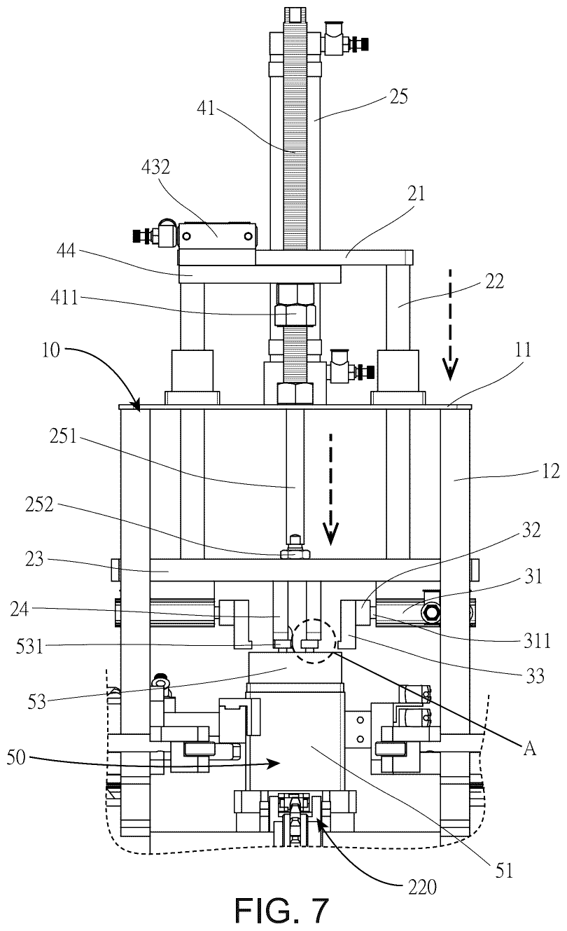

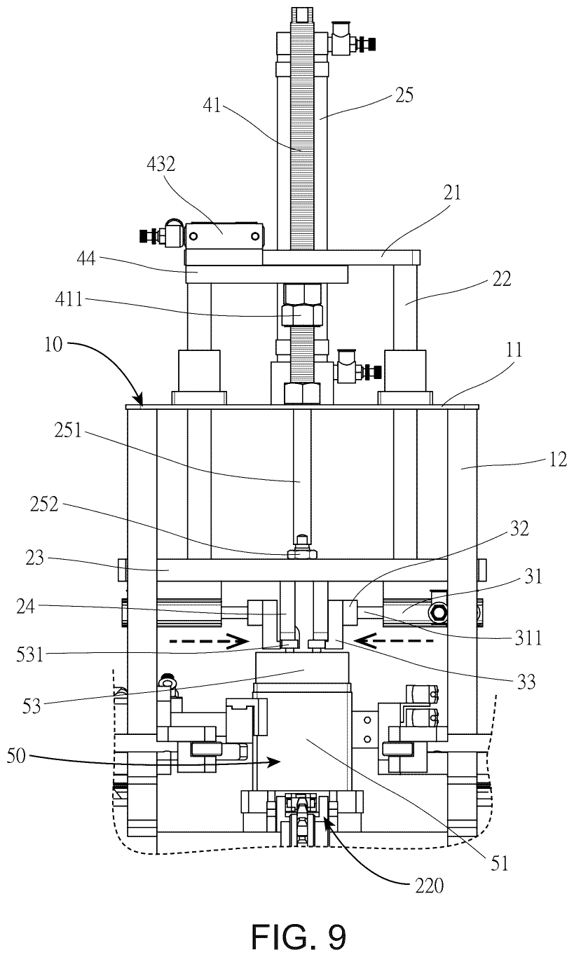

Referring to FIGS. 6 to 9 in conjunction with FIGS. 1 and 4, an operation of the invention is discussed in detail below in which pressing and positioning operations of a half-finished lead-acid battery 50 are performed twice. The lead-acid battery 50 is placed on the movement unit 220 and includes a housing 51 and a plurality of compartments 52 each for accommodating a cell electrode plate group 53. The cell electrode plate group 53 includes two lead bridges 531 at tops of front and rear ends respectively, and two connection members 532 each disposed besides the lead bridge 531. When the lead-acid battery 50 is transported to a position directly under the support structure 10, the controlling unit 210 instructs the first actuators 25 to actuate. And in turn, the first piston 251 extends to lower the second hoisting plate 23. And further in turn, the pressing block 24, the piston members 22, and the first hoisting plate 21 lower until the plate member 44 contacts both the first nut set 411 and the second nut set 431. Also, the pressing block 24 presses the lead bridges 531 of the cell electrode plate groups 53 so as to position the cell electrode plate groups 53 in the compartments 52. At the same time, the second sensor 46 is activated to transmit a signal to the controlling unit 210. And in turn, the controlling unit 210 instructs the first actuator 25 to stop and instructs each second actuator 31 to extend the second piston 311 which in turn pushes the pushing block 33 toward the lead bridges 531. As such, the cell electrode plate groups 53 are positioned in the compartments 52. This finishes the first pressing and positioning operation of the half-finished lead-acid battery 50.

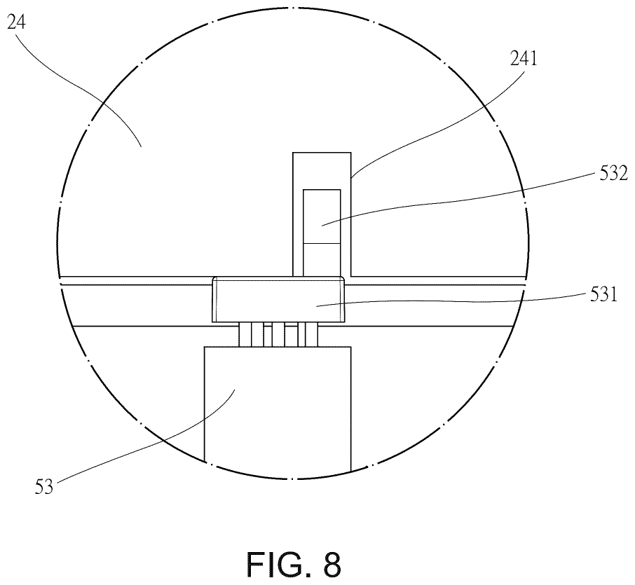

As shown in FIG. 8 specifically, with the provision of the troughs 241, the pressing block 24 may press the lead bridges 531 of the cell electrode plate groups 53 and the connection members 532 of the cell electrode plate groups 53 may be partially disposed in the troughs 241 to prevent the pressing block 24 from pressing the connection members 532. As a result, precision of the positioning is increased.

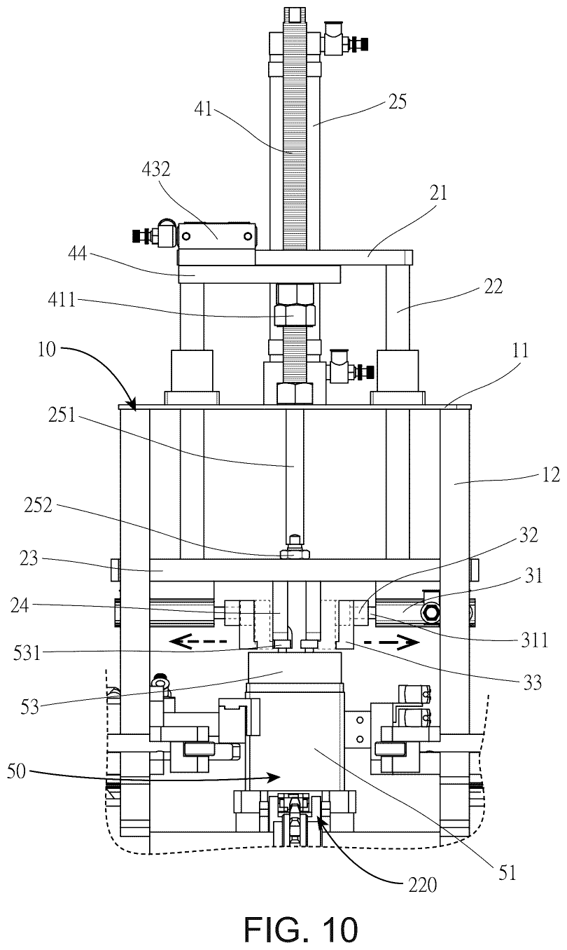

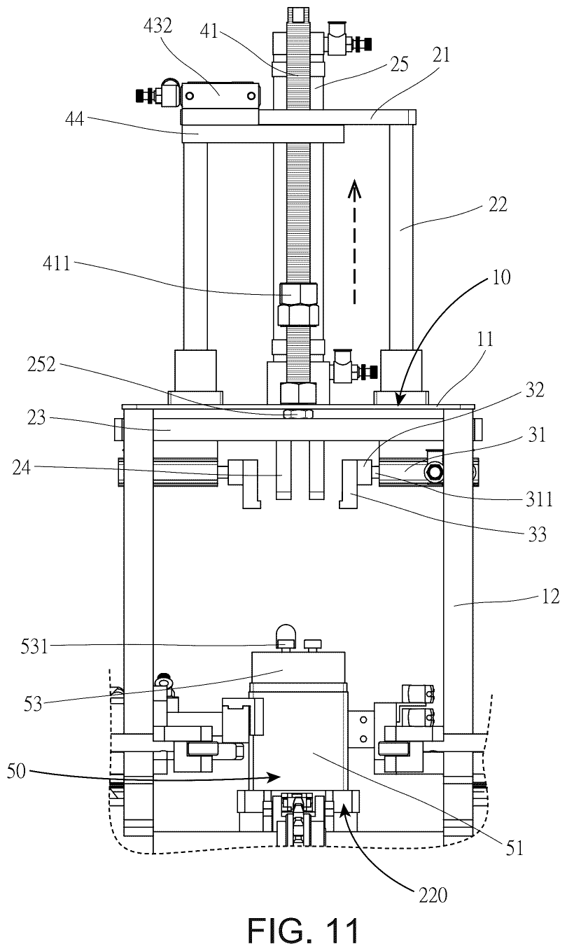

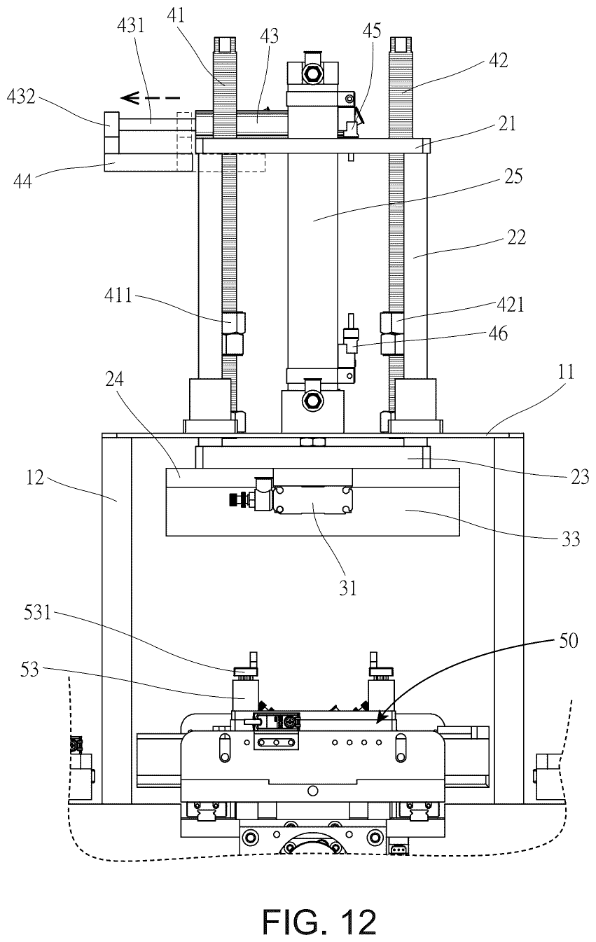

Referring to FIGS. 10 to 12 in conjunction with FIG. 1, after the first pressing and positioning operation of the half-finished lead-acid battery 50 has finished, the controlling unit 210 instructs each second actuator 31 to retract the second piston 311. And in turn, the follower plates 32 and the pushing block 33 move rearward to leave the lead bridges 531. At this time, the controlling unit 210 instructs the first actuator 25 to retract the first piston 251. And in turn, the second hoisting plate 23, the pressing blocks 24, the piston members 22, and the first hoisting plate 21 lift until the nut 252 contacts the top plate 11. At the same time, the first sensor 45 is activated to transmit a signal to the controlling unit 210. And in turn, the controlling unit 210 instructs the first actuator 25 to stop and instructs the third actuator 43 to extend the third piston 431 which in turn moves both the idler plate 432 and the plate member 44 outward. As such, the groove 441 of the plate member 44 leaves the first threaded shank 41.

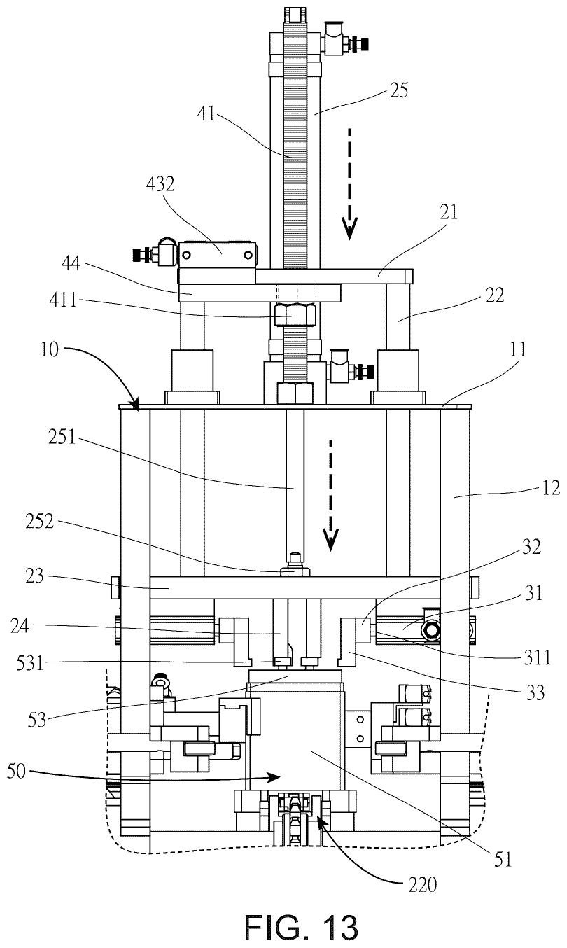

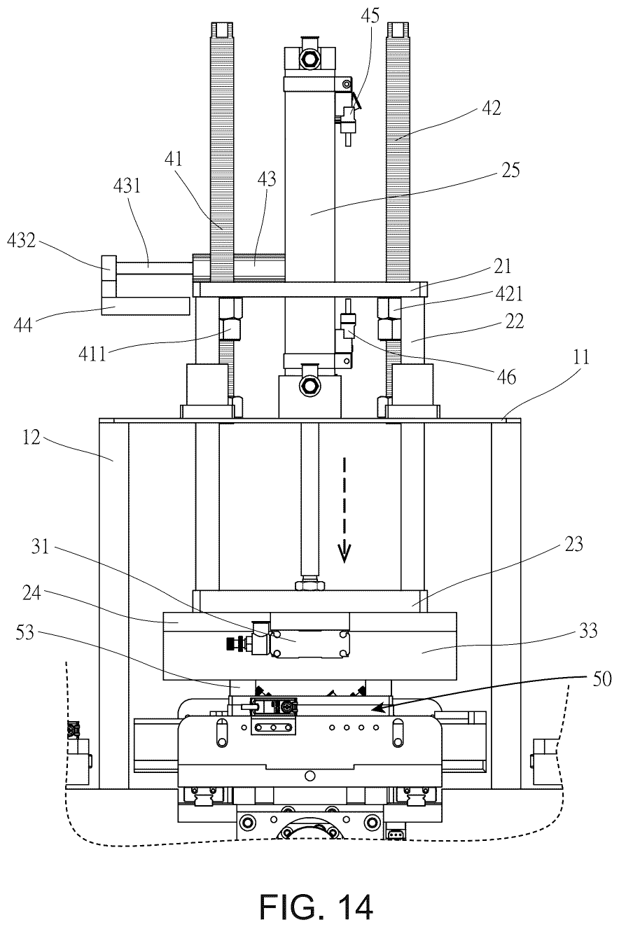

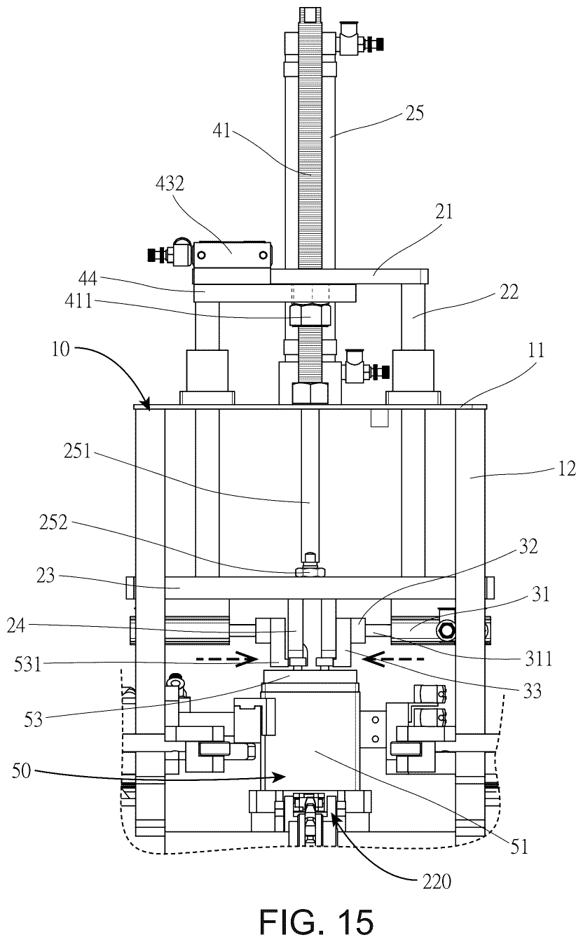

Referring to FIGS. 13 to 15 in conjunction with FIGS. 4 and 6, a second pressing and positioning operation of the half-finished lead-acid battery 50 is discussed in detail below. After the groove 441 of the plate member 44 has left the first threaded shank 41, the lowering movement of the first hoisting plate 21 is not blocked by the plate member 44 and thus, the first hoisting plate 21 may downward move a distance greater than that of the first lowering movement until the first hoisting plate 21 contacts both the first nut set 411 and the second nut set 421. This causes the pressing block 24 to further press the lead bridges 531 of the cell electrode plate groups 53. As such, the cell electrode plate groups 53 are fastened in the compartments 52. Further, the pushing blocks 33 move to press the lead bridges 531. This positions the cell electrode plate groups 53 in the compartments 52 again. As a result, the second pressing and positioning operation is finished with a finished lead-acid battery 50 being obtained.

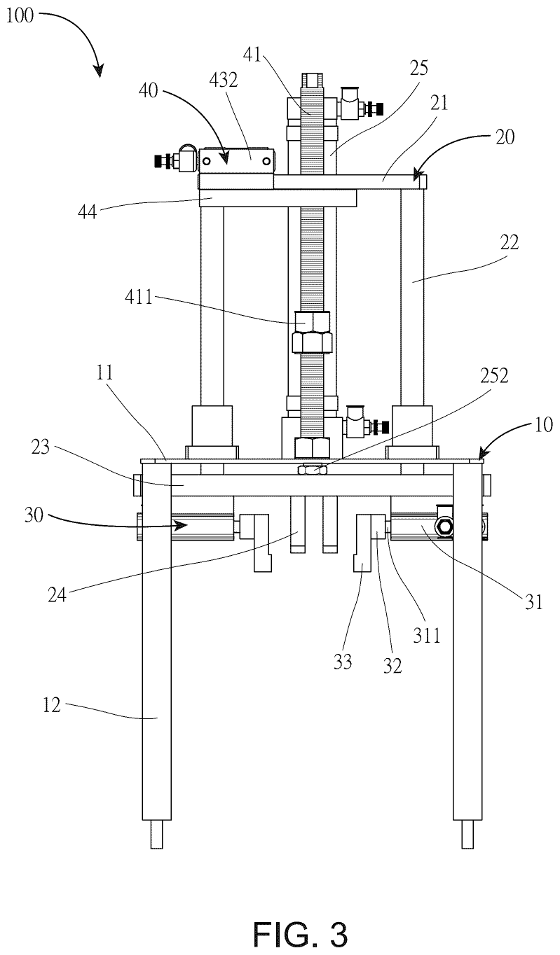

The invention has the following advantages and benefits in comparison with the conventional art: as shown in FIGS. 3 and 6, with the provision of the hoisting unit 20 and the clamping unit 30, the pressing block 24 presses the lead bridges 531 of the cell electrode plate groups 53. As such, the cell electrode plate groups 53 are fastened in the compartments 52. Further, the pushing blocks 33 move to press the lead bridges 531. This positions the cell electrode plate groups 53 in the compartments 52 again. As a result, the pressing and positioning operation of the half-finished lead-acid battery 50 is finished with a finished lead-acid battery 50 being obtained. The drawbacks of the conventional assembling process of the lead-acid battery are eliminated. Moreover, both labor and time are saved, and efficiency is increased.

While the invention has been described in terms of preferred embodiments, those skilled in the art will recognize that the invention can be practiced with modifications within the spirit and scope of the appended claims.

What is claimed is:

1. A positioning apparatus for cell electrode plate groups of a lead-acid battery, comprising:
a support structure comprising a top plate and a plurality of legs extending downward from four corners of the top plate to support the top plate;
a hoisting unit comprising a first hoisting plate, a plurality of piston members, a second hoisting plate, two pressing blocks, and a first actuator wherein the first hoisting plate is disposed above the top plate, first ends of the piston members are secured to a bottom of the first hoisting plate and second ends thereof pass through the top plate to secure to the second hoisting plate, the second hoisting plate is disposed under the top plate, the pressing blocks are secured to a bottom of the second hoisting plate and spaced apart by a predetermined distance, the first actuator passes through the first hoisting plate to secure to the top plate, and the first actuator includes a first piston passing through the top plate and threadedly secured to the second hoisting plate so that the first piston is configured to move the second hoisting plate which in turn lifts or lowers the pressing blocks, the piston members, and the first hoisting plate; and
a clamping unit comprising two opposite second actuators and two pushing blocks wherein each of the second actuators are secured to a bottom of the second hoisting plate and disposed externally of the pressing block, and each of the second actuators include at least one second piston having an end secured to the pushing block so that the at least one second piston is configured to move one of the pushing blocks forward to approach one of the pressing blocks or rearward to leave one of the pressing blocks.

2. The positioning apparatus of claim 1, further comprising a micro adjustment unit including a first threaded shank, a second threaded shank, a third actuator, a plate member, a first sensor, and a second sensor wherein the first actuator is disposed between the first threaded shank and the second threaded shank, each of the first threaded shank and the second threaded shank pass through the first hoisting plate to secure to the top plate, the third actuator is disposed on a top of the first hoisting plate and includes at least one third piston and an idler plate secured to an end of each of the at least one third piston, the idler plate is secured to a top of the plate member, the first sensor is disposed on an upper portion of the first actuator, and the second sensor is disposed on a lower portion of the first actuator.

3. The positioning apparatus of claim 2, wherein the plate member includes a groove for allowing the first threaded shank to pass through.

4. The positioning apparatus of claim 2, wherein the first threaded shank includes a first nut set on an intermediate portion and the second threaded shank includes a second nut set on an intermediate portion respectively.

5. The positioning apparatus of claim 2, wherein the third actuator is a pneumatic or hydraulic cylinder.

6. The positioning apparatus of claim 1, wherein the clamping unit further comprises two follower plates secured to the pushing blocks respectively, and wherein each of the at least one second piston is secured to one of the follower plates so that each of the at least one second piston is secured to one of the pushing blocks indirectly.

7. The positioning apparatus of claim 1, further comprising a nut for securing an end of the first piston to the second hoisting plate.

8. The positioning apparatus of claim 1, wherein each of the pressing blocks include two spaced troughs.

9. The positioning apparatus of claim 1, wherein the first actuator and the second actuators are pneumatic or hydraulic cylinders.
